(19) United States
(12) Patent Application Publication
(10) Pub. No.: US 2008/0238193 A1
(43) Pub. Date: Oct. 2, 2008

(54) Auto (Car) inverter, & auto timer, with always-on and timed sockets and outlets

(76) Inventor: Leonard Storch, New York, NY (US)

Correspondence Address: Leonard Storch, Apt. 11F, 175 West 72nd Street, New York, NY, 10023, US

(21) Appl. No.: 12/077,968

(22) Filed: Mar. 24, 2008

Related U.S. Application Data
(60) Provisional application No. 60/920,393, filed on Mar. 28, 2007.

(51) Int. Cl. H02J 1/00; B60L 1/00; H02J 5/00

(52) U.S. Cl. 307/10.1; 307/11

(57) ABSTRACT

Improved inverters for use in cars and other vehicles, and a “Car Timer for 12v Socket” are disclosed. For example, the invention comprises embodiments including but not limited to systems, methods and apparatus such as:
(i) the inverter may have an always-active automatic-off timer;
(ii) a user settable timer to turn off the inverter;
(iii) an always-on and or a timed 12v DC socket(s);
(iv) an always-on and or a timed A.C. outlet(s) (like household outlets);
(v) a charger for rechargeable batteries including AAA, AA, C and or D batteries;
(vi) a separate “Car Timer for 12v Socket” device (without an inverter) may have a settable timer controlled 12v DC socket(s) and an always-on socket; and
(vii) lights, such as LEDs, may be used to convey more information than has been conveyed previously.

This application claims priority to U.S. Provisional Application serial number 60/920393 filed Mar. 28, 2007. The title of that Provisional Patent Application is the same as this Utility Patent Application (above). The entire contents of U.S. Provisional Application Ser. No. 60/920393 are herein incorporated by reference.

### FIELD OF USE

Embodiments of the present invention include and relate generally to an improved 12 v DC battery powered portable electrical A.C. energy source known as an inverter, and a separate auto accessory comprising a settable timer-controlled 12 v DC socket and an always on socket—that auto accessory might be called a “Car Timer for 12 v Socket.”

An inverter provides A.C. energy, similar to the A.C. energy provided from household electric outlets, so that devices that require A.C. household energy can be operated in a car or other vehicle. The improved inverter can have one or more timers built into it, and one or more DC socket(s) and or A.C. outlet(s) can be timer controlled.

### BACKGROUND

Even though fewer and fewer people smoke, auto cigar (aka cigarette) lighter sockets are still quite useful as people find more and more gadgets to plug into the sockets. For example, using the Internet to go to the “Buy.com” website and searching “inverters” can produce well over a dozen pictures of a variety of brands and models of inverters that plug into a car's cigar lighter. However, if an inverter is to supply over 175 watts of A.C. power, it is recommended to connect the inverter directly to the car's battery. A Vector inverter product provides clips for that purpose.

Black and Decker's Vector Manufacturing, Ltd., in Ft. Lauderdale, Fla., for example, offers products with different output wattage capacities. Such inverters connect to the vehicle's electrical system either via the cigarette lighter or provided clips to the positive (red) and negative (black, ground) of the electrical system. An example of a Vector inverter product, Model VEC024, 400 Watt Power Inverter, is pictured:

The Owner's Manual for this Vector inverter product, Model VEC024, 400 Watt Power Inverter, contains the following information:

“Operating Tips

5.1 Rated Versus Actual Current Draw of Equipment

Most electrical tools, appliances and audio/video equipment have labels that indicate the power consumption in amps or watts. Be sure that the power consumption of the item you wish to operate is rated at 400 watts or less (If the power consumption is rated in amps AC, simply multiply by the AC volts (110) to determine the wattage). The inverter has overload protection, so it is safe to try to operate equipment rated at 400 watts or less. The inverter will shut down if it is overloaded. The overload must be removed before the inverter can be manually restarted by reseting [sic] the on/off switch. Resistive loads are the easiest for the MA.XX 400 SST to run. However, larger resistive loads, such as electric stoves or heaters, usually require more wattage than the MAXX 400 SST can deliver. Inductive loads, such as TV's and stereos, require more current to operate than do resistive loads of the same wattage rating. Induction motors, as well as some televisions, may require 2 to 6 times their wattage rating to start up. The most demanding in this category are those that start under load, such as compressors and pumps. Testing is the only definitive way to determine whether a specific load can be started and how long it can run. The unit will simply shut down if it is overloaded. To restart the unit after a shutdown due to overloading, remove the overload and reset the on/off switch. CAUTION: This inverter will not operate high wattage appliances or equipment that produce heat, such as hair dryers, microwave ovens and toasters.

5.2 Battery Operating Time

With a typical vehicle battery, a minimum operating time of 2 to 3 hours can be expected. In most instances, 5 to 10 hours of operating time is achievable. However, Vector recommends that the operator start the vehicle every 2 to 3 hours to recharge the battery system. This will guard against any unexpected shutdown of the equipment and will ensure that there is always sufficient battery capacity to start the vehicle's engine. The inverter will sound it's alarm when DC voltage drops to 10.6 volt.

The inverter may be used whether or not the vehicle's engine is running. However, the inverter may not operate while the engine is starting since the battery voltage can drop substantially during cranking.

The inverter draws less than 0.75 ampere from the battery when it is not supplying power to a load. In most instances, the inverter can be left connected to the battery when not in use since it draws so little current when the power switch is in the ON position. However, if the vehicle is to remain unused for several days, disconnect the inverter from the battery.”

Basic Inverters provide household AC voltage to one or more standard household sockets by converting 12 v DC from auto, boat, motor home or other vehicles' electrical systems which comprise at least one battery and a battery charging system. The conversion of 12 v DC to 120 v AC is done with various electrical apparatus (inverter circuitry) well know in the inverter field of art.

Vector's U.S. patent applications describe various features and accessories in different combinations to enhance what basic inverters can do. For example, please see Vector's patents and pending patents including:
U.S. Pat. No. 6,799,993;
U.S. Pat. No. 5,982,138;
US Appl. 2006/0080972; and
US Appl. 2005/0268318.

Also see other patents and pending patents including:
Hsu's U.S. Pat. No. 6,842,356 car cigarette adaptor to power USB and Firewire ports;
Wallach's U.S. Pat. No. 6,736,531 for a timer controlled light;
Upadhye, et al's. U.S. Pat. No. 6,571,564 timed container warmer and cooler for home or car;
Chow's U.S. Pat. No. 6,167,000 multi timer display;
Reid's U.S. Pat. No. 6,125,082 for a cigarette timer to reduce smoking;
Moore's U.S. Pat. No. 5,463,203 for a vehicle heater;
Ng's U.S. Pat. No. 5,408,068 electric heater for a vehicle;
Rohr, et al's., U.S. Pat. No. 5,274,736 pressurized heating apparatus with a timer for making coffee in an automobile;
Ratti, et al's. U.S. Pat. No. 3,969,610 timed liquid heating device;
Lai's Remote FM US Appl. 2007/0010220;
Kuo's Bluetooth US Appl. 2006/0019718;
Britto's US Appl. 2005/0242770 timed accessory adaptor wired to a baby bottle heater, a baby blanket, an auxiliary light or a phone charger;
Yeh's Music US Appl. 2005/0228520; and
Kotani et al's. US Appl. 2005/0218136 car battery heater with timer

This link has inverter products: For example, http://www.pricewatch.com/brands/cables/vr3-1.htm such as VR3 4-in-1 Car Power Inverter FM, USB, Mfg. Part No. VRTP4N1.

This link http://jackstoolshed.zoovy.com/product/40107A?META=bizrate-40107A shows a multi-featured product which is described as follows: “Ultimate Emergency Car Starter with Air Compressor and AC Power Inverter The essential travel companion! Like having your own personal tow truck along—boost a dead battery or power household appliances and electronics with the built-in AC inverter and any 12-volt device with 3 DC outlets. Plus bright lights to do it all safely in the dark and warning lights to alert others. So useful and practical, you'll want one in every vehicle. Makes a GREAT gift! “Five essential automotive safety and convenience tools in one compact, easy-carry unit 1) Powerful 1200 peak/600 starting amp jump starter with built-in heavy-gauge cables 2) AC Inverter powers electronics and appliances up to 150 volts 3 4) Three DC power outlets for cell phones, etc. 5) 2 powerful work lights & two warning flashers.”

Universal adaptor products for auto 12 v DC sockets, to provide different DC voltages to power and or charge various gadgets, include Radio Shack's High-Power Universal DC Adapter, Model: 273-1818, which provides for 4.5, 6, 9, 10 or 12 v DC via a variety of adaptaplugs, A,B,H,M, Universal Vehicle DC-to-DC Adapter.

Another Radio Shack product is Model: 273-1811, which can power “Most Portable Consumer Electronics, 3, 4.5, 6, 7.5, or 9VDC output, Adaptaplugs A,B,H,M.”

Different combinations of the embodiments of the invention may be used to provide added sales appeal and marketing sizzle to inverter products and other auto accessory products.

### SUMMARY OF THE EMBODIMENTS OF THE INVENTION

According to one embodiment of the present invention, an inverter could have one or more 12 v DC sockets (cigarette lighter sockets) built in. One socket, “Socket A,” could be always on, i.e., always hot with 12 v DC when the inverter is plugged into the auto system, or be always on only when the inverter is plugged in and turned on. One other socket, “Socket B,” could be a switched socket, i.e., the socket could be switched on and off with the timer controlled switch of the inverter.

According to another embodiment of the present invention, an inverter can have two A.C. outlets. One A.C. outlet can have A.C. power whenever the inverter is turned on and another A.C. outlet can be controlled by a timer.

According to another embodiment of the present invention, an inverter can have two A.C. outlets. One A.C. outlet can have A.C. power whenever the inverter is turned on and another A.C. outlet can be controlled by a timer. The inverter can also have one or more DC sockets. The same timer or another timer can control a 12 v DC socket and another DC socket can always have power when the inverter is turned on or always have power whenever the inverter is plugged in.

According to another embodiment of the present invention, a separate auto accessory is disclosed comprising a settable timer-controlled 12 v DC socket, and it could also have an always on socket. This accessory could be called a “Car Timer for 12 v Socket.” An inverter or other devices could be plugged into this auto accessory and be timed and or not timed if plugged into the always on socket.

Different embodiments of the present invention can provide convenience and flexibility for an inverter user and or a timer user. According to the embodiments of the present invention, inverters and timers may also be provided with a settable timer to turn the inverter Off, or On and Off once, or On and Off multiple times.

Any suitable timer may be used to implement the timing functions described herein. For example, mechanical timers or various electronic timers or both may be used.

### BRIEF DESCRIPTION OF THE DRAWINGS

Different embodiments of the present invention are illustrated by way of example and not limitation in the figures of the accompanying drawings in which like references indicate like or similar parts, and in which:

FIG. 1 schematically shows a mechanical type car timer product with two 12 v cigar (aka cigarette) lighter sockets, one always hot and one timer controlled.

FIG. 2 schematically shows an inverter for a car with a rotary switch controlled timer for simultaneously controlling the inverter circuitry and a cigar socket and an always hot socket.

FIG. 3 schematically shows an inverter for a car with one timer for simultaneously controlling the inverter circuitry and a cigar socket and an always hot socket.

FIG. 4 schematically shows an inverter for a car with a timer for controlling the inverter circuitry and another timer for controlling a cigar socket and an always hot socket.

FIG. 5 schematically shows an inverter for a car with rotary switch controlled timer for selectively controlling the inverter circuitry or a cigar socket or both and an always hot socket.

FIG. 6 depicts the mechanical type car timer product with two 12 v cigar lighter sockets, one always hot and one timer controlled, schematically shown in FIG. 1.

FIG. 7 depicts a similar product as depicted in FIG. 6 but for direct installation in a car cigar socket and with a digital timer (also called an electrical timer) and a USB charger port.

FIG. 8 schematically shows an inverter for a car with an always hot socket and with a timer for simultaneously controlling the inverter circuit and a cigar socket.

FIG. 9 schematically shows an inverter for a car with an always hot socket and with a timer for simultaneously controlling a first inverter circuit and a cigar socket and another inverter circuit which operates independently of the first timer controlled inverter.

FIG. 10 schematically shows an inverter for a car with an always hot socket and with a timer for simultaneously controlling via a timed DPST switch the output of an inverter circuit and a cigar socket. FIG. 10 has two timed A.C. outlets and two un-timed A.C. outlets.

### DESCRIPTION OF PREFERRED EMBODIMENTS

According to embodiments of the present invention, a user settable timer would be useful—a person could leave his vehicle with the inverter set for a time to turn the inverter off. For example, the person could set the timer for a period long enough to charge his laptop (or camera or run his fan to keep a sleeping pet cool till sundown or whatever) and then turn the inverter off completely to save the car battery. Or the timer could be set to turn off a sun lamp or heat lamp or a therapeutic vibrator after the recommended length of treatment has occurred.

Further, according to this embodiment, if no turn-off time has been set, if the inverter is so equipped, a suitable sensor well known in the art could be used, for example, to detect that the vehicle's engine has not been running for any time preselected by the inverter manufacturer, for example, two hours, or for a time set by the user, for example, when the user first gets the inverter, a safety automatic “off” feature could automatically turn the inverter off.

A safety automatic “off” feature could automatically turn the inverter (or any other device equipped with such a feature, such as an AA battery charger device) off even if the engine is operating after a preselected period of time. For example, a device that would require no more than, say, four hours (or any period of time) could be turned off after having been plugged in for four hours.

As mentioned, a timer device according to embodiments of the present invention could be user settable. For example, the user could select some number of minutes before the timer turns off, or some number of hours or increments thereof before it turns off. In one embodiment for example, a timer could operate a switch to open the 12 v DC vehicle battery power to the inverter. The timer could also be set to an always on position if the user did not want the timer to turn the inverter off.

According to another embodiment, a timer could be a separate unit that allows, for example, the inverter user to use the timer or not to use the timer with the inverter, or to use the timer with another device altogether that requires 12 v DC for some other purpose.

A separate timer unit may be sold as a separate product (without an inverter) and called a “Car Timer for 12 v Socket.” For example, the separate timer could be equipped with one or more 12 v DC sockets. One socket could be always on, i.e., always hot with 12 v DC when the timer is plugged into or connected to the 12 v DC auto system. One other socket could be a switched timed socket, i.e., 12 v DC to the socket could be switched on and off by the timer. In other words, the timer would operate the switched socket on and off according to the time set on the timer.

### Indicator Lights

The sockets for these inverter and timer embodiments could have associated therewith one or more indicator lights such as single or multi-colored LED's to indicate the status of the socket associated therewith. For example, a two color, red or green, LED could light in one or more of the following ways for its associated timer-controlled socket: red=off and green=timer is providing power.

However, some more information could also be provided to the user via the LED: steady green=timer in an always-on position; blinking green=power is provided according to the timer. The rate of blinking could indicate how much time remains on the timer.

Assume for explanation purposes that one complete blink period consists of one on and off time (one on time+one off time=one blink period). For example, if the blink period was one second (on and off occurs in one second, five such periods in five seconds), it could indicate less time remains and an on off period that lasts longer than one second could indicate that more time remains.

The period could provide more specific information. For example, instructions with the products could inform the user that one on off period per second means that 15 minutes remain before the timer will turn the socket, inverter, other device or object off, and that one period per two seconds=30 minutes remaining, and one period per four seconds=60 minutes, etc. The user could time the periods and be more informed about how much time is left on the timer without looking at anything else.

If an inverter, for example, had no timer but had a safety automatic “off” feature described above and had an LED(s) as described herein, the systems and methods being described for conveying information with the LED light may be the only available way of conveying more information to the user. For example, a steady on green LED indicating that AC power is being supplied by an inverter could start blinking as described herein to give an indication as to how long before the safety automatic “off” feature was going to turn the inverter off.

Getting back to a user timing the periods to be more informed about how much time is left on the timer without looking at anything else: For example, the instructions for the inverter or other device could suggest that the user count the number of periods in ten seconds and divide that number of periods into 10 seconds to determine the length of the period in seconds.

This system and method being described of conveying information with LEDs could be coupled with more ways to convey information. For example, the length of the on time for a given LED color could be different than the length of the off time in a given period. For example, a short off time compared to a longer on time could indicate that the auto battery is well charged and not about to run low. As the battery drains, a longer off time and a corresponding shorter on time could indicate that the auto battery is closer to running low.

This system and method being described of conveying information with LEDs could be coupled with even more ways to convey more information, general information about a variety of subjects, especially subjects that a driver would be interested in.

For example, the LED could convey information with a variety of different meanings by alternating a red and a green LED, or alternating the colors from a multi-color LED, while changing the frequency to the period and changing the amount of on time compared to the off time within the period. These LED visual indications could be used along with audio information.

For example, a sound generator in the car could produce a sound at a given audio frequency while turning the sound on and off as described for one complete LED blink period (one sound on time+one sound off time=one sound period). The sound period could convey additional information by changing the amount of sound on time compared to the sound off time within a sound period.

If sound generators were used as described, it might be advantageous, e.g., it might be less intrusive, if the sound were not steady (sound not on all the time). For example, the sound could be sounded for some number of seconds, such as 5 seconds, between periods of silent (no sound for some number of minutes), such as 5 minutes. For example, sound on for 5 seconds, no sound for 5 minutes, sound on for 5 seconds . . . etc. The on time and off time could be adapted to suit the particular circumstances.

The brightness of the light from the LEDs could be varied, as could the loudness produced from the sound generator, as well as the frequency (pitch) of the sound, and the possible combinations of light and sound could be increased so that the variety of different information that can be conveyed with the systems and methods being described herein would expand greatly. The blink periods and sound periods and on time compared to off time, etc., could be adapted to suit the particular device or application in which these systems and methods of conveying information are to be utilized.

### DETAILED DESCRIPTIONS OF CAR TIMERS AND INVERTERS WITH TIMERS

In an embodiment of the present invention, using two 12 v DC sockets, a stand-alone timer device (separate from the inverter) could power one device always on and another device on and off according to the timer setting so that a 12 v DC device could be turned on and off with the timer, and could be set to turn off after a selected amount of time has transpired. The inverter could be operated from either of these two sockets, as could any other device.

In an embodiment of the present invention, a separate timer as described with one or more 12 v DC sockets could be sold separately, or along with an inverter, or along with a device other than an inverter.

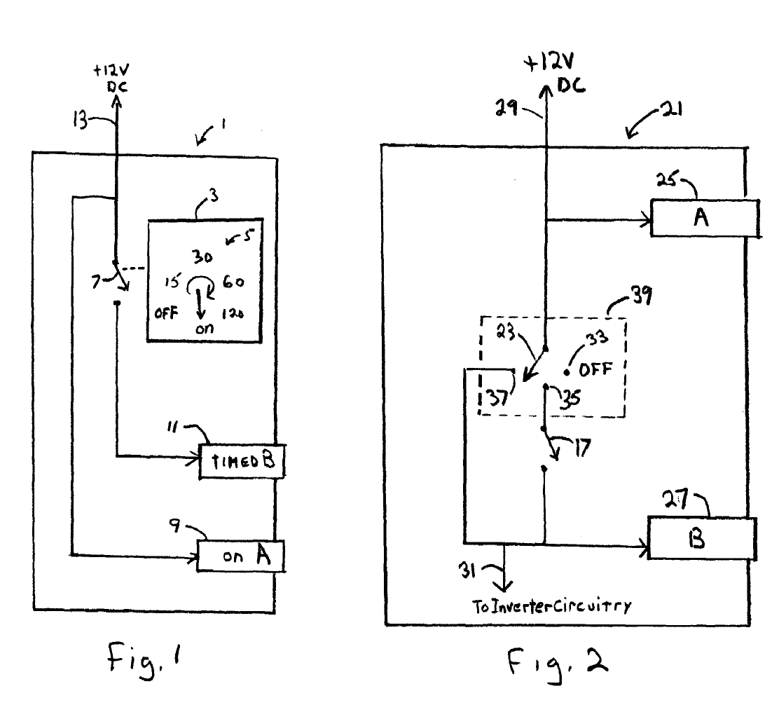

FIG. 1 illustrates a separate “Car Timer for 12 v Socket” described above. In FIG. 1, a separate timer unit 1 is shown with two 12 v DC sockets 11 and 9. Whenever timer unit 1 is connected by line 13 to 12 v DC, socket 9 is powered with the same 12 v DC, as shown in FIG. 1.

In FIG. 1 and other Figs. showing the embodiments of the present invention, a main power switch (not shown) to turn 12 v DC on and off may be used for the timer apparatus and or inverter with timer apparatus illustrated.

In FIG. 1, a mechanical spring operated well-known settable timer device is depicted by 3 (as used for example on less expensive or older microwave ovens, or common small electric toaster ovens). The dial with settings on the face of timer 3 is generally shown as 5 and has positions indicated, in clockwise rotation, from Off to 15, 30, 60 and 120 minutes and On (always on, not timed to turn off). Off is the fully counterclockwise position, and On is the fully clockwise position. The On position is always on, i.e., switch 7 is closed as described below, and the settings in between Off and On are timed in minutes to turn Off according to where the dial 5 is set.

The timer 3 operates switch 7 which powers timed socket 11 as shown. Switch 7 as shown is a single pole, single throw, SPST, type of switch; in one position of its two positions switch 7 is open and in the other position it is closed. Switch 7 could be a relay operated switch or another suitable switch know in the art. In the fully counterclockwise Off position, switch 7 is open. As the timer's rotatable dial knob is rotated clockwise from Off, switch 7 closes and provides 12 v DC power down the line shown to socket 11; i.e., power to socket 11 is controlled Off or On according to the setting on timer 3.

In another embodiment, a timer with one or more of the features similar to what is described above for a separate timer could be built into the inverter. For example, if the timer is built into the inverter, the user could plug another 12 v DC device into a built-into-the-inverter always on 12 v DC Socket A. Or the user could plug an other 12 v DC device into a built-into-the-inverter switched 12 v DC Socket B, so that, if the timer was set to turn the inverter off, the other device could also be turned off when the inverter is turned off by the timer.

For example, referring to FIG. 2, an inverter 21 is shown with two 12 v DC sockets 25 and 27. Whenever the inverter is connected by line 29 to 12 v DC, Socket A 25 is powered with the same 12 v DC, as shown in FIG. 2 (similar to socket 9 in FIG. 1).

In FIG. 2, a basic one-wafer three position rotary switch to be operated by the inverter user is depicted in the dashed enclosure 39. The user can rotate the hand operated control knob (not shown) of switch 39 so that the wiper arm 23 connects 12 v DC power to connection positions 37, 35 or 33.

When wiper 23 is connected to position 37, power is supplied through line 31 to operate the inverter circuitry and to Socket B 27 to operate whatever may be plugged into socket 27. In this position (wiper 23 to connection 37), Socket A 25 and Socket B 27 are powered with the same 12 v DC as the inverter (and timer switch 17, described below, is out of the circuit, and it makes no difference if switch 17 is closed or open).

When wiper 23 is connected to position 35, power to the inverter and to Socket B 27 is controlled by timer switch 17. Timer switch 17 is operated by a timer device as shown and described for FIG. 1 above (but not shown in FIG. 2). Only when timer switch 17 is closed according to the setting on the timer (not shown) will the inverter and Socket B 27 have 12 v DC power. A make before break rotary switch 39 may be preferred so as to avoid momentarily breaking contact between position 37 and 35 as the rotary switch 39 is rotated between 37 and 35 in either direction.

When wiper 23 is connected to position 33 OFF (which is open, not connected to anything), power to the inverter and to Socket B 27 is turned off but power is still available at Socket A 25 (and it makes no difference if timer switch 17 is closed or open).

Rotary switch 39 in FIG. 2 is not actually needed to provide described functionality. As mentioned, when wiper 23 is connected to position 35 in FIG. 2, power to the inverter and to Socket B 27 is controlled by timer switch 17.

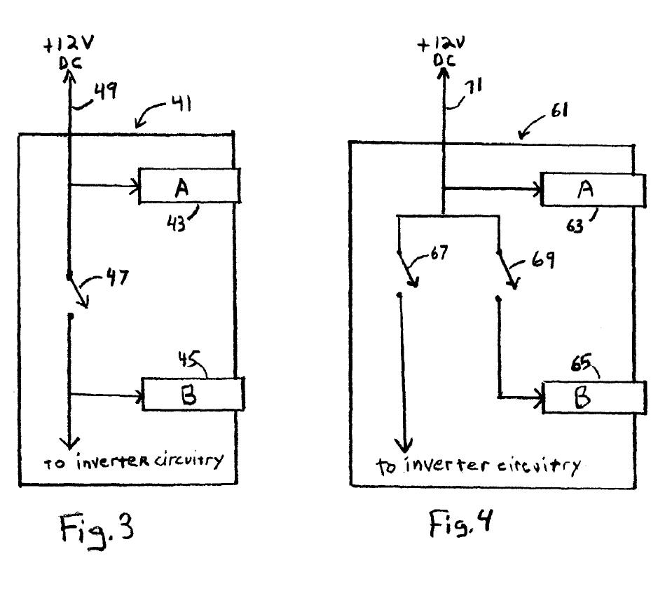

For example, referring to FIG. 3, an inverter 41 is shown with two 12 v DC sockets 43 and 45. Whenever the inverter is connected by line 49 to 12 v DC, Socket A 43 is powered with the same 12 v DC, as shown in FIG. 3. Power to the inverter and to Socket B 45 is controlled by timer switch 47. Timer switch 47 is operated by a timer device as shown and described for FIG. 1 above but not shown in FIG. 3. Only when timer switch 47 is closed according to the setting on the timer (not shown) will the inverter circuitry and Socket B 45 have power.

Referring to FIG. 4, an inverter 61 is shown with two 12 v DC sockets 63 and 65. Whenever the inverter is connected by line 71 to 12 v DC, Socket A 63 is powered with the same 12 v DC, as shown in FIG. 4. Power to the inverter circuitry and to Socket B 45 is separately controlled by two timer switches 67 and 69 which are operated by two timer devices each operating as shown and described for FIG. 1 above but not shown in FIG. 4. Only when timer switch 67 is closed according to the setting on its timer (not shown) will the inverter circuitry have power, and only when timer switch 69 is closed according to the setting on its timer (not shown) will Socket B 65 have power. With this arrangement, the inverter and whatever device is plugged into Socket B 65 can be separately and independently controlled allowing the user greater flexibility than shown and described above.

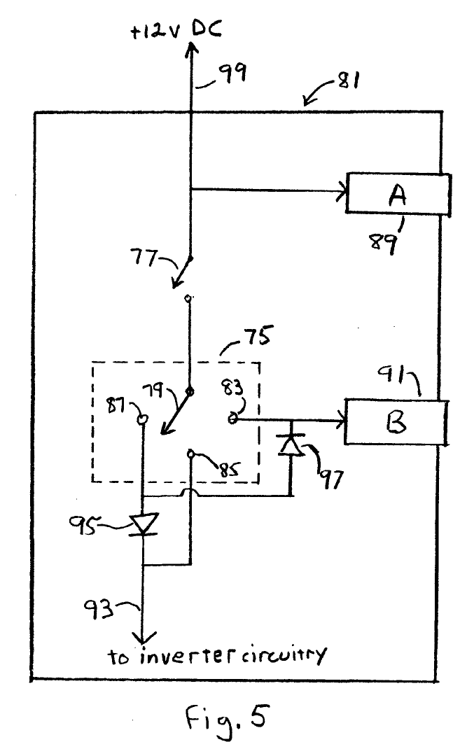

Referring to FIG. 5, an inverter 81 is shown with two 12 v DC sockets 89 and 91. Whenever the inverter is connected by line 99 to 12 v DC, Socket A 89 is powered with the same 12 v DC, as shown in FIG. 5.

Power to the inverter and to Socket B 91 is initially controlled by timer switch 77. Timer switch 77 is operated by a timer device as shown and described for FIG. 1 above but not shown in FIG. 5. Only when timer switch 77 is closed according to the setting on the timer (not shown) will the basic one-wafer three position rotary switch depicted in the dashed enclosure 75 have power at the wiper arm 79. Switch 75 is to be operated by the inverter user. The user can rotate the hand operated control knob (not shown) of switch 75 so that the wiper arm 79 connects 12 v DC power to connection positions 87, 85 or 83.

When wiper 79 is connected to position 87, 12 v DC power is supplied through diode 95 to line 93 to operate the inverter circuitry and through diode 97 to supply power to Socket B 91. When wiper 79 is connected to position 85, power is supplied to line 93 to operate the inverter circuitry but diode 95 blocks power to diode 97 so that Socket B 91 does not have power. When wiper 79 is connected to position 83, power is supplied to Socket B 91 but diode 97 blocks power to diode 95 so that the inverter circuitry does not have power.

A make before break rotary switch 75 may be preferred so as to avoid momentarily breaking contact when switching from one rotary position to another.

The arrangement for FIG. 5, using one timer switch device 77 and one rotary switch 75, can power either the inverter or Socket B 91 separately and independently from each other. The arrangement for FIG. 5 can also power the inverter and Socket B 91 together and the timer setting would necessarily be the same setting for both the inverter and Socket B 91. The arrangement for FIG. 5 is not as flexible as the arrangement in FIG. 4 which uses two timer switch devices (67 and 69) to achieve the added flexibility.

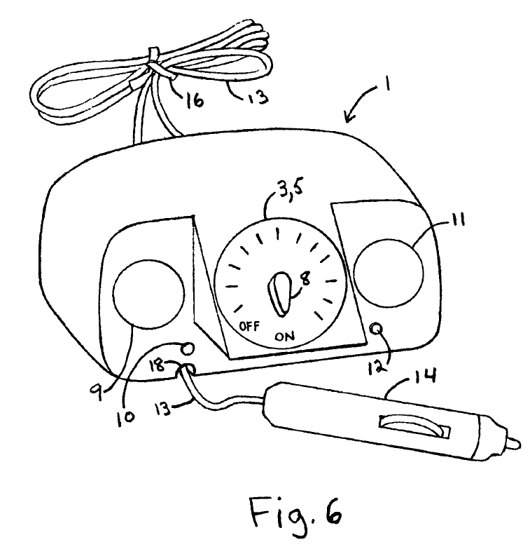

FIG. 6 depicts a “Car Timer for 12 v Socket” unit 1 as a product as mentioned above. The unit 1 may be placed on the top part of a car's dashboard and secured with Velcro (not shown). The general operation of FIG. 6 was described referring to the schematic shown in FIG. 1. Like components in FIGS. 1 and 6 have like numbers and the description of their use and operation is similar to what was described for FIG. 1.

FIG. 6 shows line 13 in more detail. Line 13 is a two wire cable 13 that connects the unit 1 to the 12 v plug 14 that is inserted into the car's cigar (aka cigarette) lighter to power the unit 1. As shown in FIG. 1, socket 9 is always on when the unit 1's 12 v DC connector plug 14 is plugged in.

A wire tie 16 may be used to keep the extra length of line-cable 13 neatly together behind the unit 1. A recess or a holder (neither is shown), such as a two part strap with a snap, in or on the back of the unit 1 may be provided to hold the excess line-cable 13 which may be wire tied 16. To keep the installation of the unit 1 on the dashboard or an other flat surface looking neat, a recessed channel 18 may be provided on the bottom of the unit 1 running from front to back to accommodate cable 13 so that the unit 1 may lie flat on the top of the dashboard without the cable 13 going around the unit 1.

FIG. 6 shows a mechanical timer 3,5 which operates similar to what was described for the face 3 of timer 5 for FIG. 1. FIG. 6 shows knob 8 which operates the timer 3,5. Knob 8 is shown in the always-on position. Timer 3,5 controls timed socket 11 as described for FIG. 1. FIG. 6 show a light 12 associated with socket 11. Light 12 could be a two color, red-green LED and operate in one of the ways described above. Two lights, such as a red and a green light, could be used instead light 12.

FIG. 6 also shows a light 10 associated with socket 9. Light 10 could be a Green LED and only be turned on when the unit 1 is plugged in to indicate power is available at socket 9. Light 10 could also operate as described above; for example, it could indicate the car's battery condition.

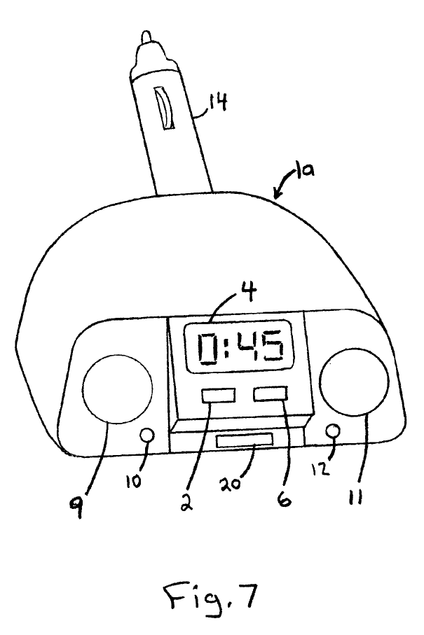

FIG. 7 depicts another “Car Timer for 12 v Socket” unit 1a as a product but with different features than FIG. 6. The unit 1a in FIG. 7 may be inserted directly into the car's cigar lighter to power the unit 1a via 12 v DC plug 14. Plug 14 may be adjustable up and down if a pivot (not shown) were provided so that the unit 1a would be easier to install or better accommodated or more convenient to use in a larger variety of car cigar lighters.

As shown in FIG. 1, socket 9 is always on when the unit 1 is plugged in. Socket 9 has a light 10 as described for FIG. 6.

The timer for use in unit 1a of FIG. 7 is an electrical type with a display panel 4. Electrical timers are well known in the timer art. An electrical timer(s) could also be used in any of the inverters shown in FIGS. 2 to 6 and in the car socket timer shown in FIG. 1. In FIG. 4, one mechanical and one electrical timer could be used.

Display panel 4 of the electrical timer could be an LCD or LED or other suitable display. If an LCD display is used, a backlight could be provided automatically and vary in brightness as appropriate for changing ambient lighting conditions, or a manual control could be added to the unit 1a to control a backlight for the display. If an LED display is used the intensity of the readout may be adjustable as described for the backlight of the LCD display.

The timer with display panel 4 in FIG. 7 may be set with push buttons 2 and 6. For example, if 2 is pushed and held in, it could cycle through possible settings in 15, 30 and 60 minute intervals such as Off, 15, 30, 45, 60, 90, 120, 150, 180, 240, 300, 360, 420 and 480 (e.g., the upper limit, 8 hours) and On, i.e., always on. If the desired time setting is past because the user does release the button soon enough, the user could hold in button 2 until the desired setting comes around again.

Button 2 could increment in other fashions. For more convenient operation, there may be a pause on the Off and On settings or other settings. The selected timer setting could be started when button 6 is pushed and released, i.e., power would be applied to socket 11 for the length of time selected, and the timer could start to count down to Off as time passes. Light 12 could be activated in a variety of ways as described above. Pressing and holding in button 2 while time remains from a previous setting could turn off power to socket 11.

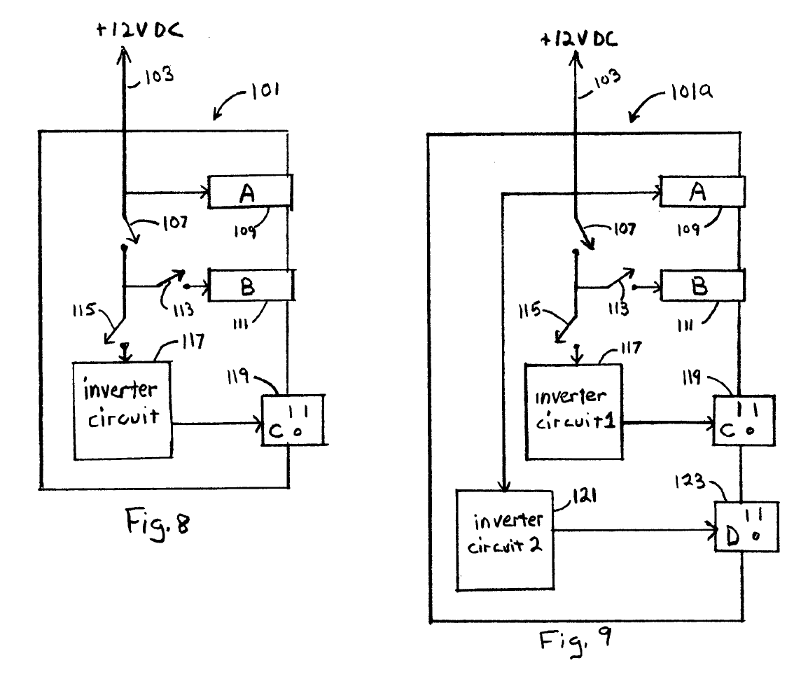

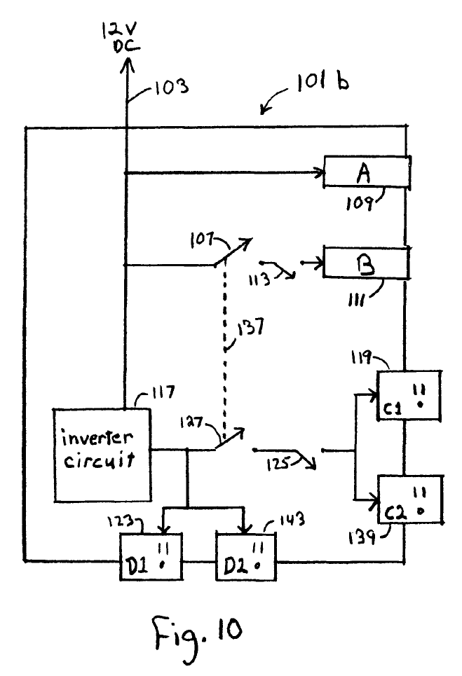

Referring now to FIG. 8, an inverter 101 is shown. Referring to FIG. 9, an inverter 101a is shown. Referring to FIGS. 8 and 9, an inverter circuit 117 is shown with two 12 v DC sockets 109 and 111. Whenever the inverter is connected by line 103 to 12 v DC, Socket A 109 is powered with the same 12 v DC, as shown in FIGS. 8 and 9. Power to the inverter circuit 117 and to Socket B 111 is controlled by one timer switch 107 (which may be operated by a timer as described above). Only when timer switch 107 is closed according to the timer device (not shown) can the inverter circuitry or Socket B 111 have power.

If the timer (not shown) is on, i.e., timer controlled switch 107 is closed, Socket B 111 will have power if switch 113 is closed. As shown, switch 113 and switch 115 are manually operated SPST switches; switch 113 controls Socket B 111 and switch 115 controls the inverter circuit 117. If the timer (not shown) is on, inverter circuit 117 will have power if switch 115 is closed so that the inverter will provide A.C. power to Outlet C 119 (similar to a household electric outlet).

With the arrangement in FIGS. 8 and 9, the inverter circuit 117 and whatever device is plugged into Socket B 111 can be simultaneously controlled by timer switch 107 depending on the manual setting of switches 113 and 115 as described.

Referring now only to FIG. 9, another inverter circuit 121 and A.C. Outlet D 123 is provided. Inverter circuit will have power to operate anytime Socket A 109 has power and thus inverter circuit 121 will provide A.C. power to Outlet D 123 independent of the timer switch 107.

Referring now to FIG. 10, an inverter 101b is shown. In FIG. 10, like in FIGS. 8 and 9, an inverter circuit 117 is shown with two 12 v DC sockets 109 and 111. Whenever the inverter is connected by line 103 to 12 v DC, Socket A 109 is powered with the same 12 v DC, as shown in FIGS. 8 and 9 and 10. In FIG. 10, power to Socket B 111 is controlled by timer switch 107 (which may be operated by a timer as described above). Only when timer switch 107 is closed according to the timer device (not shown) can Socket B 111 have power.

As in FIGS. 8 and 9, if the timer (not shown) in FIG. 10 is on, i.e., timer controlled switch 107 is closed, Socket B 111 will have power if manual switch 113 is closed.

FIG. 10 has two always-on A.C. household outlets. In FIG. 10, inverter circuit 117 will have 12 v DC anytime Socket A 109 has 12 v DC so that A.C. outlets D1 123 and outlet D2 143 will always have A.C. power as shown.

FIG. 10 also has two timed A.C. household outlets, C1 119 and C2 139. In FIG. 10, inverter circuit 117 will have 12 v DC anytime Socket A 109 has 12 v DC. Timer switch 127 is ganged with timer switch 107, i.e., timer switches 107 and 127 are shown as a double pole, single throw, DPST, switch, mechanically ganged together, as shown by dashed line 137, and operated by a timer device (not shown). Outlets C1 119 and C2 139 will have power when timer switch 127 is closed if manually operated switch 125 is also closed (by the user).

As shown, switch 113 and switch 125 are manually operated SPST switches; switch 113 controls Socket B 111 and switch 125 controls A.C. outlets C1 119 and C2 139. In practice, it may be preferable if manually operated switch 125 was a DPDT switch (not shown) so that two wires are used to control the A.C. power to the two A.C. outlets switch 125 controls.

With the arrangement in FIG. 10, the A.C. outlets C1 119 and C2 139 and whatever device is plugged into Socket B 111 can be simultaneously controlled by the timer (not shown) controlling timer switches 107 and 127 respectively depending on the manual setting of switches 113 and 115 respectively as described. A.C. outlets D1 123 and D2 143 have power whenever Socket A 109 has 12 v DC as mentioned above.

Multiple DC sockets and or A.C. outlets could be color coded so that the color would indicate always-on versus timer controlled.

Provision could be made with mechanical or electrical timers, such as those discussed or shown herein or such as one using a display panel similar to what is shown (panel 14) in FIG. 7 or in FIG. 1 (3,5), to also to turn a device, such as an inverter, Off, or On and Off once, or On and Off multiple times.

Provision could also be made for electrical timers, such as depicted by display panel 14 in FIG. 7, to also indicate the voltage of the car's electrical system. For example, pressing 6 and holding it in could switch display panel 4 to indicate the car voltage, and pressing and holding 6 again could switch back to show what time remains on the timer. A timer display panel 4 as shown in FIG. 7 and described would be suitable for use in an inverter.

Various other ways to set and operate the electrical timer are of course possible. Timer unit 1a could also be equipped with a USB port 20 as shown in FIG. 7 to charge certain devices such as cameras, IPODs, laptops. Also, a firewire port (not shown) could be provided.

The arrangements shown and described for the embodiments above could be combined in various ways or could be simplified if less settings and or components were provided and or if only one “Socket A” or one “Socket B” or one A.C. outlet were provided, as will be apparent to those skilled in the art.

What is shown and described for the Figs. above is by way of example of how things could be done and also illustrative of what else could be done. For example, more user selectable options are possible with more switches and or switches with more contacts and or more rotary wafers and wipers and or with more sockets and or with one or more diodes. These components could be operated by the user or controlled by one or more timer devices set by the user as will be understood by those skilled in the art.

For example, in ways similar to what is described above and in ways different than described, the user could select among the following self-descriptive settings 1), 2), 3) and 4) and other setting are possible as well:
1) Turn all power to the inverter unit off after a set time expires, thus also turning off Socket B if it was on, and Socket A (the otherwise always on socket).
2) Turn power to Socket B off after the set time expires but do not turn off power to the inverter (or to Socket A) (similar to the arrangement described for FIG. 4).
3) Turn power to the inverter off after the set time expires but do not turn off power to Socket B (or to Socket A) (similar to the arrangement described for FIG. 4).
4) Only turn power to “Socket A” (the otherwise always on socket) off after a set time expires (but do not turn off power to the inverter or Socket B).

Other combinations of course are possible. Inverter users will no doubt appreciate the flexibility these arrangements provide, and they may even find reasons to utilize all possible combinations.

A built in DC voltmeter similar to the type described for FIG. 7, or a needle-pointer and dial-scale type, could be included in the inverter and connected to the 12 v DC auto system to allow the user to monitor the auto electrical system.

Inverters with one or more of the features shown and described herein could also be offered as standard or optional built in equipment in sedans and or SUVs (not shown). For example, an inverter could be permanently integrated and mounted in a dash board or consol unit. These built in auto inverters may have associated covers to cover them when not in use.

Timer devices according to embodiments the present invention could be powered by various means including mechanical means described above, clockworks mechanisms or otherwise, or the timer could be powered by the 12 vDC auto system, or by the AC output of the inverter or a stepped-down AC voltage, or by self contained batteries which may or may not be rechargeable batteries. Timers could be digital or analogue and have numeric or alphanumeric readouts and be set by dials, push buttons, toggles, slides, pegs (as used in the Intermatic Timer Model TN311D89 shown below) or otherwise.

### Sample Timers

Any suitable timer may be used to implement the timing functions described herein. For example, mechanical timers or various electronic timers or both may be used. For example, timer devices well known in the timer art similar to the following timing devices may be suitable and could be adapted and or integrated to provide these novel timing features for improved inverters or other embodiments of the present invention:

Home Depot offers an Intermatic Timer, Model TN311D89, described as follows: 15 Amp 1750 Watt 125 Volt AC 24 Hr. Heavy-Duty Timer.

Amazon.com offers a Timex Heavy-Duty Program Timer, Item model number L12/881/0299004, which is described as follows:
Timer to automatically switch lamps and appliances on and off
Can set up to 12 on/off switchings per day
Program repeats every 24 hours
Override thumbwheel; grounded outlet
Sleek case design

Next is a Flexcharge DC Timer Controller described thusly:
Flexcharge DC Timer Controller
Item# Flextimer
Regular price: $85.00
Sale price: $71.50
Availability: Usually ships the next business day

This controller will directly control both AC and DC loads up to 16 amps non-inductive (lights, heaters etc.) or 8 amp inductive loads (motors, pumps, fans, etc.). Will control up to 240 volt AC or DC (but not recommended for over 48 volts DC). This requires a 12 volt battery to operate the timer and internal relay. The timer draws only a few milliamps, so can operate from one side of a 24 volt battery system without battery damage, or for remote pump systems you can use one of the small Concorde 33 Amp-hour batteries with a small trickle charge panel and Sunguard controller, or often you can tap off the existing pumping panels with a charge controller to feed a 12 volt battery. Since it draws only a very tiny current, it will not affect pump operation even if charging the battery at the same time.

The Flexcharge Real Time Programable Timer is a 12 hr, 8 event, clock based programmable 8A load controller. Multiple Load ON and OFF times are programmed into this real time clock controller. Each day can be programmed with its own unique timing pattern. Eight ON and eight OFF events can be programmed independently.

Example; Use one ON event to have a light come on at 7 pm every day then use seven different OFF events to turn the light OFF at a different time each day. This controller may be used in conjunction with the sSCLC or LVD 12/24 to have the load come ON at dusk, then shut OFF at a pre-programmed time.

Features:
Internal battery maintains clock and programmed memory for up to 3 months with no external power.
Consumes less than 3 mA in standby mode.
Drives up to 8 A Inductive Loads or 16 A Resistive Loads.
Isolated relay contacts allow user to directly control 115 Vac Loads
Reverse Polarity Protected.

Manual override allows the user to manually turn the load ON and OFF as desired. Easy to Use Terminal Block for simple installation

The Flexcharge Real Time Programmable Timer is a 24 hr, 8 event, clock based programmable 8 A load controller. Multiple Load ON and OFF times are programmed into this real time clock controller. Each day can be programmed with its own unique timing pattern. Eight ON and eight OFF events can be programmed independently. Example; Use one ON event to have a light come on at 7 pm every day then use seven different OFF events to turn the light OFF at a different time each day.

Features:
Internal battery maintains clock and programmed memory for up to 3 months with no external power.
Consumes less than 3 mA in standby mode.
Drives up to 8 A Inductive Loads or 16 A Resistive Loads.
Isolated relay contacts allow user to directly control 115 Vac Loads Reverse Polarity Protected.

Manual override allows the user to manually turn the load ON and OFF as desired. Easy to Use Terminal Block for simple installation

PRGTMR12V

This link for Super Feeder, feeders for pond and aquarium fish and other pets, offers timers that operate from various voltages and draw less than 2 milliamps: http://www.super-feed.com/dctimer.html This is how Super Feeder describes the product pictured below:

“Really neat DC OR AC timer! You can do lots of things with this guy. It is 2 ¾″ square by 1 ⅝″ deep. Driven by a quartz controlled stepper motor, it has a 1 second in 24 hr accuracy! This model will loose time only when disconnected from its power source, but it's easy to reset. Program disc with 144 switch actuators in 10 minute increments. Extremely simple and fast setting. Indication of switch-on period by red disc section and connection by trip-tab terminals. Time of day is very visible via the hands on the dial. The whole dial is covered with removable clear lens. Set time of day and weekday by rotating a center glass panel. Easy programming by moving the switch actuators. Best of all, is that it will work with a voltage range of 6 to 24 VDC or AC! Its current draw is next to none at 1.9 milliamp. Single-pole-double-throw (one normally closed while other is open) switch rating is 16 Amps/250V.”

According to embodiments of the present invention, inverters may be provided with timers and or a built in or an associated charger accessory for AAA, AA, C and D rechargeable batteries. Battery chargers for household rechargeable batteries are well known. For example, the one shown below could be plugged into one of the 12 v DC sockets described above:

Manufacturer Battery Biz has this model offered on Buy.com:

AA/AAA Charger w 4 AA Batteries-B-9700. It is described as follows:

Charges two or four AA/AAA NiCad/NiMH batteries in two to four hours Red/green LED gauge indicates charge status Over-voltage and short circuit protection for total charge safety.

According to embodiments of the present invention, a battery charger for rechargeable batteries and or a settable timer(s) to turn the inverter and or sockets off, or on and off one or more times and a set one time fixed safety timer could be combined with one or more of the following features:
1) USB port with 5 v DC.
2) 12 v DC cigarette lighter socket(s).
3) DC voltmeter, dual meter and/or multi-meter
4) LCD display for AlphaNumeric information and or a waveform.
5) Single or multi-color convenience light(s).
6) Cord storage compartment, or a retractable DC cord.

Certain changes and modifications of the embodiments of the invention disclosed herein will be readily apparent to those skilled in the arts.

I claim:

1. A timer device comprising:
a timer which receives 12 v DC power and provides at least one 12 v DC power output for a time period set in the timer;
a 12 v DC power plug adapted to be plugged into a powered 12 v DC socket of a vehicle, the timer connected to receive 12 v DC power when the plug is plugged into a vehicle's powered 12 v DC socket;
at least one 12 v DC socket connected to receive 12 v DC power provided by the at least one 12 v DC power output of the timer;
wherein, the at least one 12 v DC socket provides 12 v DC output power from the device for the set time period.

2. The timer device of claim 1, wherein the timer comprises at least one other 12 v DC socket connected to provide 12 v DC output power independently of the time period set in the timer.

3. The timer device of claim 1, comprising a cable connected to the plug, the timer being connected to receive 12 v DC power from the cable when the plug is plugged into a vehicle's powered 12 v DC socket.

4. The timer device of claim 1, comprising at least one indicator light to provide operational information.

5. The timer device of claim 1, comprising at least one display to display information regarding voltage.

6. The timer device of claim 1, comprising another timer with a preset time period which is started when the device is turned on, the other timer connected to turn the device off after the preset time period expires.

7. The timer device of claim 1, comprising another timer with a preset time period which is started when the device is turned on if the vehicle's engine is not running, the other timer connected to turn the device off after the preset time period expires if the vehicle's engine has not been run.

8. A timer device comprising:
at least one 12 v DC to household AC power inverter;
a timer which receives 12 v DC power and provides 12 v DC power to the inverter for a time period set in the timer;
a 12 v DC power plug adapted to be plugged into a powered 12 v DC socket of a vehicle, the timer connected to receive 12 v DC power when the plug is plugged into a vehicle's powered 12 v DC socket;
at least one AC outlet connected to receive household AC power provided by the at least one inverter;
wherein, the at least one AC outlet provides household AC output power from the device for the set time period.

9. The timer device of claim 8, wherein the device comprises at least one other AC outlet connected to receive household AC power provided by the at least one inverter and provide household AC output power from the device independently of the time period set in the timer.

10. The timer device of claim 8, wherein the device comprises at least one other AC outlet connected to receive household AC power provided by at least one other inverter and provide household AC output power from the device independently of the time period set in the timer.

11. The timer device of claim 8, wherein the device comprises at least one 12 v DC socket connected to provide 12 v DC output power whenever the plug is plugged into a vehicle's powered 12 v DC socket independently of the time period set in the timer

12. The timer device of claim 8, wherein the device comprises at least one 12 v DC socket connected to receive 12 v DC power provided by the timer to provide 12 v DC output power from at least one 12 v DC socket for the set time period.

13. The timer device of claim 8, comprising a cable connected to the plug, the timer being connected to receive 12 v DC power from the cable when the plug is plugged into a vehicle's powered 12 v DC socket.

14. The timer device of claim 8, comprising at least one indicator light to provide operational information.

15. The timer device of claim 8, comprising at least one display to display information regarding voltage.

16. The timer device of claim 8, comprising another timer with a preset time period which is started when the device is turned on, the other timer connected to turn the device off after the preset time period expires.

17. The timer device of claim 8, comprising another timer with a preset time period which is started when the device is turned on if the vehicle's engine is not running, the other timer connected to turn the device off after the preset time period expires if the vehicle's engine has not been run.
